(19) United States
(12) Patent Application Publication
(10) Pub. No.: US 2025/0094950 A1
(43) Pub. Date: Mar. 20, 2025

(54) EZ-VSF KIOSK SYSTEM

(71) Applicant: CHRISTOPHER RUSS, HUDSON OAKS, TX (US)

(72) Inventor: CHRISTOPHER RUSS, HUDSON OAKS, TX (US)

(21) Appl. No.: 18/886,869

(22) Filed: Sep. 16, 2024

Related U.S. Application Data
(60) Provisional application No. 63/582,605, filed on Sep. 14, 2023.

(51) Int. Cl. G06Q 20/18; G06Q 10/0639; G07C 5/00; H04W 4/029

(52) U.S. Cl. CPC G06Q 20/18; G06Q 10/06398; G07C 5/008; H04W 4/029

(57) ABSTRACT

A kiosk system includes a remote electronic device, a dispatch system, and a local kiosk system networked together to facilitate the capture, processing, and retrieval of a vehicle. The remote electronic device includes a software application configured to track and handle repossession of a vehicle. The dispatch system is in communication with the remote electronic device and includes a GPS system linked through a mobile network to provide location information related to the vehicle and a repo driver handling the repossession of the vehicle. The local kiosk system includes an interface for access by a user to initiate retrieval of the vehicle, the local kiosk system is in communication with the dispatch system to track the temporary release and movement of the vehicle.

### CROSS REFERENCE TO RELATED APPLICATIONS

This application claims the benefit of an earlier filing date and right of priority to U.S. Provisional Application No. 63/582,605, filed 14 Sep. 2023, the contents of which is incorporated by reference herein in its entirety.

### BACKGROUND OF THE INVENTION

### 1. Field of the Invention

The present application relates to a system for impounding vehicles, and more particularly to a kiosk and mobile app configured to streamline the acquisition and release of vehicles.

### 2. Description of Related Art

Vehicle storage and impound lots have been around for a long time and have changed over the years. Impounding was primarily utilized as a sanction for traffic infractions in the early days of vehicles. Unpaid fines or missed court dates sometimes resulted in vehicles being impounded on the side of the road or in police stations. Impound lots started to appear as a distinct and specialized type of facility in the 1960s and 1970s. These parking facilities, which were frequently found in industrial locations, were created to accommodate the increasing number of automobiles being impounded.

Many cities started privatizing its impound lots in the 1980s and 1990s, hiring private firms to run and maintain the facilities. As a result, both the number of impound lots and the services they provided significantly increased. Impound lots have been subject to more regulation in recent years, particularly with regard to fees and how car owners are treated. The amount of fees that impound lots may charge and the amount of notice that owners must receive before their vehicles are sold or otherwise disposed of are both governed by laws that have been passed in many states. In many cities and towns today, automobile storage facilities and impound lots are an integral element of the transportation infrastructure and still play a significant role in law enforcement and traffic management.

Due to the high number of seized vehicles, many vehicle storage facilities are overcrowded. In addition to creating safety risks and other problems, this often makes it difficult for owners to quickly retrieve their cars. If the vehicle is not promptly retrieved, the fees for storing impounded vehicles, which are frequently high, can quickly add up. For vehicle owners, especially those with low incomes or other financial difficulties, this may result in hardship. It can be challenging for vehicle owners to understand the costs and procedures involved in getting their cars back from some car storage facilities because of the lack of transparency in their business practices. Confusion and frustration may result, and it might be more challenging for vehicle owners to get their vehicles back as a result.

It can be challenging for vehicle owners to access vehicle storage facilities because they are frequently situated in difficult-to-reach locations. This can be particularly difficult for people who don't have access to reliable transportation or who are unable to get to the facility in any other way. For their treatment of vehicle owners, some vehicle storage facilities have come under fire, including claims of mistreatment and disrespect. Vehicle owners may not want to return their cars or use the facility in the future as a result of this negative experience.

Although strides have been made in the repossession and car storage industries, shortcomings remain. It is desired that a system be provided that is more transparent and clearer to the public about how to retrieve and access their car once impounded.

### BRIEF SUMMARY OF THE INVENTION

It is an object of the present application to provide a system designed to streamline and improve the reclaiming and release of vehicles impounded in a storage facility after towing. Currently, considerable amounts of physical paperwork or computer time are required to process, store, and release a vehicle. In addition, personnel have to meet with the public, expending their time and patience in dealing with car owners while recovering their vehicles. The system streamlines the process of releasing vehicles and, in most cases, will allow the owners to reclaim their vehicles without the lot personnel having to be involved.

It is a further object of the present application that the system includes a kiosk with a user interface, such as a keypad, to allow a user to enter a code for opening the gate to a lot. The system guides the client through all the necessary details and paperwork necessary to reclaim the vehicle. The kiosk contains all the scanning and camera systems required to record documents and determines if a vehicle can be released.

Once all the necessary documents are scanned and recorded on the built-in database or hard drive, the kiosk will determine the appropriate fee required, and a credit card, debit card, or cash receiver is enabled to take payment. When the client's payment is made, the system will issue a gate code to open the gate and direct the customer to their vehicle. The system will eliminate public interaction and reduce employee stress due to possible upset clients. The system is also highly efficient and will release personnel for other tasks reducing costs and confusion over vehicle recoveries. The system increases the safety of the employees as well as streamlines the process for the public.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a kiosk system according to an embodiment of the present application.

FIG. 2 is a schematic of an exemplary programming tree of the kiosk system of FIG. 1.

FIG. 3 is a schematic of application hardware for use with electronic devices within the system of FIG. 1.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

The ezVSF kiosk system of the present application is configured to streamline and improve the reclaiming and release of vehicles impounded in a storage facility after towing. Currently, considerable amounts of physical paperwork or computer time are required to process, store, and release a vehicle. In addition, personnel have to meet with the public, expending their time and patience in dealing with car owners while recovering their vehicles. The ezVSF kiosk system streamlines the process of releasing vehicles and, in most cases, will allow the owners to reclaim their vehicles without the lot personnel having to be involved.

The ezVSF kiosk system consists of a kiosk in the lobby or front of the business building. The keypad for entering a code for opening the gate may be at either a walk-up lot or a drive through lot gate. The ezVSF kiosk system guides the client through all the necessary details and paperwork necessary to reclaim the vehicle. The kiosk system contains all the scanning and camera systems required to record documents and determines if a vehicle can be released.

Once all the necessary documents are scanned and recorded on the built-in database or hard drive, the kiosk system will determine the appropriate fee required, and a credit card, debit card, or cash receiver is enabled to take payment. When the client's payment is made, the ezVSF kiosk system will issue a gate code to open the gate and direct the customer to their vehicle. The ezVSF kiosk system will eliminate public interaction and reduce employee stress due to possible upset clients. The system is also highly efficient and will release personnel for other tasks reducing costs and confusion over vehicle recoveries. The ezVSF kiosk system increases the safety of the employees as well as streamlines the process for the public.

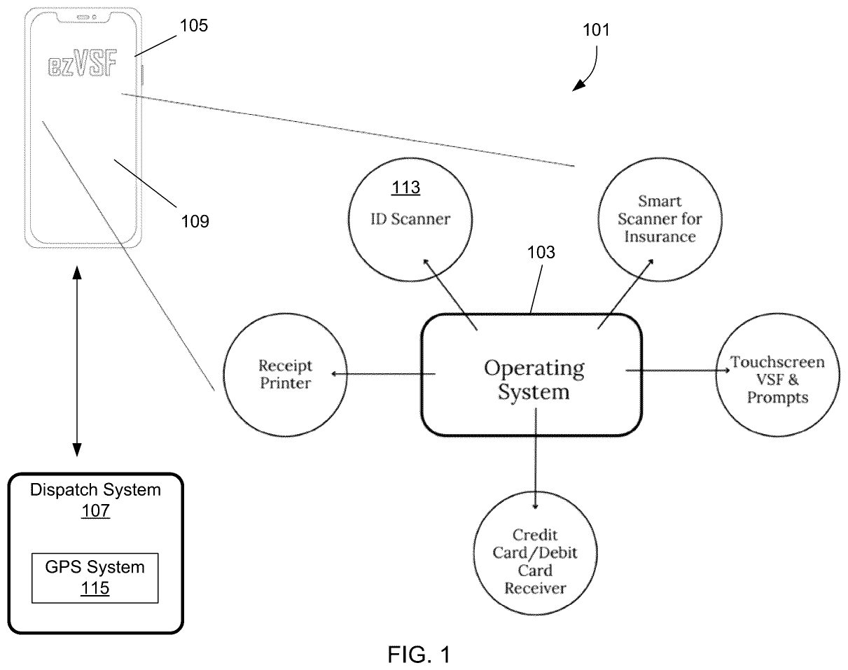

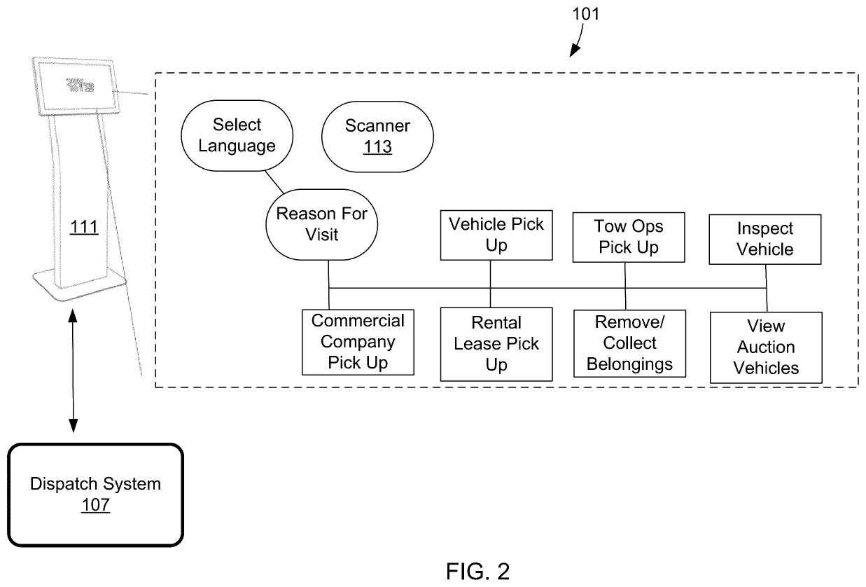

Referring now to FIGS. 1 and 2 in the drawings, views of the ezVSF kiosk system 101 is provided. System 101 is configured to be a state-of-the-art system configured to guide customers through a series of prompts, to enable customers to retrieve their vehicles effortlessly. It also may include a remote electronic device 105 using a mobile software application 103 for use by towing operators (repo driver) to assist them in conducting their business. System 101 is configured to be mobile compatible and may be accessed via a QR code. System 101 streamlines the vehicle release process by freeing up employees to focus on other important tasks.

As a result, the potential for conflicts caused by human interaction during the release process is greatly reduced or eliminated altogether. Additionally, the system's 101 reliance on electronic copies drastically reduces the amount of waste generated by old methods, making it an environmentally friendly solution that saves space. The incorporation of system 101 also significantly reduces human error in the process, making it a reliable and efficient system for vehicle storage facilities.

In particular with FIG. 1, a phone 105 and representative software app capabilities are provided for use with system 101. The Phone App 103 is used by the towing operator to assist in communication with dispatch and to conduct business. The Phone App is a crucial tool for efficient dispatch processes, and it is fully integrated with a Dispatch System 107 and GPS to ensure accurate tracking of all calls and real-time updates on driver locations. The app's user-friendly interface 109 enables drivers to easily accept and manage dispatched calls, with the ability to mark vehicles as impounded and provide detailed information to dispatch for improved communication and response times. In addition to dispatch functionality, the app 103 also includes features that benefit drivers, such as the ability to accept card payment and issue receipts electronically via email or text messaging, streamlining the payment process and improving customer satisfaction.

Moreover, the app 103 also provides drivers with an option to input their personal information such as DL, medical card, towing license information and expiration dates, which triggers an alert when the expiration date is approaching. This feature ensures that drivers remain compliant with all relevant licensing and regulatory requirements. The app's tracking system also records weekly earnings as a percentage of calls completed, providing drivers with an overview of their earnings and encouraging them to work more efficiently. The app also includes a push-to-talk feature, enabling drivers to communicate directly with dispatch, and a smart touch phone interface that simplifies communication and reduces errors. By providing drivers with a reliable, user-friendly tool that streamlines the dispatch and payment processes while also providing valuable data and compliance features, the Phone App 103 is an essential component of any successful impound operation.

Although described as being used by the operators of the towing company only, it is understood that the Phone App 103 and its capabilities may be modified for use by the vehicle owners to locate their vehicles, pay fees, and do any transaction necessary to access or retrieve their vehicle.

As seen in FIG. 2, the kiosk 111 of system 101 is illustrated with its functional capabilities. System 101 is a versatile and efficient solution that addresses language barriers and streamlines the vehicle release process. System 101 ideally includes a kiosk 111 to allow vehicle owners access to their vehicle and pay fees. By offering multiple language options, kiosk 111 ensures that customers of all backgrounds can easily navigate the system. The kiosk utilizes an ID scanner 113 or picture ID uploaded to the mobile site to match customer names to information uploaded from DMV reports of impounded vehicles. This ensures that the correct vehicles are released to the rightful owners. If a match is not found, the system prompts the customer to provide additional documentation, such as title or insurance information. If no match is found, the kiosk 111 will prompt the customer to fill out a VSF to pick up the vehicle.

The scanner 113 can recognize information from various documents, including DLs, passports, federal IDs, VSFs, titles, TDLRs, cab cards, and insurance. In rare cases where an uncommon document is presented, dispatch can electronically verify it with a notification on the Dispatch System. All necessary documentation is collected and stored on an external hard drive, sorted by call number for easy access. Once ownership is verified, the kiosk collects payment via credit card, debit card, or cash. Credit card and debit card processing fees are charged according to the type of impound, and vehicles can be released at no charge when directed by the Dispatch System 107. After payment is made, the kiosk 111 provides customers with directions for accessing and retrieving their vehicle and generates a receipt that can be printed or emailed. The receipt includes all required information and a randomly generated set of gate codes based on the reason for the visit.

Interfaces, such as keypads are present at both walk and drive through gates for easy access, and once the exit gate is used, vehicles are automatically removed from inventory. The kiosk system 101 includes a computer, scanner, camera, external hard drive, credit card and debit card processor, cash and change receiver, receipt printer, gate, and gate code generator. The kiosk system 101 effectively eliminates clerical errors and personnel shortages, making it a reliable and efficient solution for vehicle storage facilities.

The Dispatch System 107 is a crucial component of the impound process and must be integrated seamlessly with the kiosk 111, and system 101 in general, as well. To achieve this, it should be linked to ADD and can extract information from the DMV report. Furthermore, it should share a screen with the GPS to provide easy dispatch visuals and be linked to the mobile app for dispatching drivers efficiently. The Dispatch System 107 should also be a learning system, which tracks the average call times for repo drivers and recommends the best dispatch decisions and provides accurate ETAs. It should also use vehicle information to determine hook rates, pickup and drop-off addresses, and mileage rates to give customers accurate quotes. The new call screen should be optimized and have a simple step-by-step questionnaire to help dispatch input calls efficiently and effectively with all necessary information. If the plate or VIN is entered, the vehicle information should be automatically filled. Additionally, a link should be established through Google, which allows customers to request tows electronically and input vehicle information themselves. This link will provide customers with quotes and ETAs according to the Dispatch System 107. The system should also notify dispatch of missing information promptly, such as police department notification report numbers, and various steps not met for impounded vehicles such as notifications and vehicles impounded for long periods, preparing them for auction.

System 101 also includes a GPS System 115. The GPS System is a critical component of the vehicle impound process, and as such, it is integrated with the Dispatch System and shares the same screen. It is also connected to the phone app to provide real-time updates on the status of the fleet and drivers, including when they are onsite, in tow, and at drop-off. The system always tracks the vehicles and repo drivers, allowing dispatchers to make quick and informed decisions. It is designed to be tamperproof and durable to withstand heavy use and abuse. To ensure maximum visibility and security, the GPS System will feature a 5-camera system, including an internal 360-degree GPS-enabled camera that is connected to the mobile network. This camera will provide live streaming video that can be viewed by administrators and will store 24 hours of footage in the cloud with automatic overwriting.

To prevent unauthorized access, drivers will be notified that they are being monitored. The internal camera will also have event detection and notification capabilities for accidents, extreme braking, and distracted driving, allowing dispatchers to take appropriate action as needed. Additionally, the system will include four external cameras that will record to the dashboard hard drive, capable of storing one week's worth of data for optimal accident damage protection. These features will help to coach drivers on safe and effective use of the system, while also providing enhanced security and protection for both the drivers and the impounded vehicles.

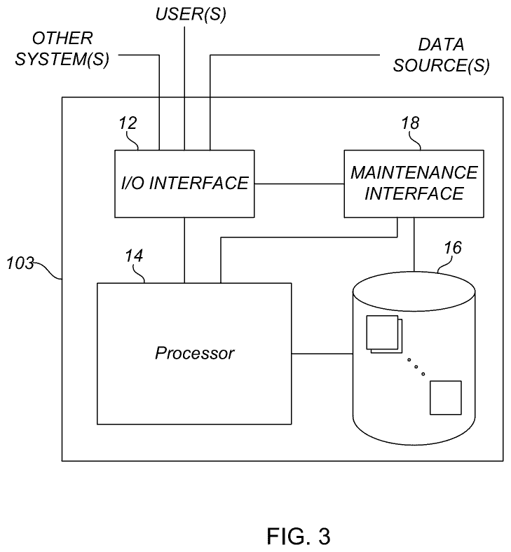

Referring now also to FIG. 3 in the drawings, a schematic of application hardware is illustrated for use with any and all computerized systems in system 101. The software app 103 includes an input/output (I/O) interface 12, an processor 14, a database 16, and a maintenance interface 18. Alternative embodiments can combine or distribute the input/output (I/O) interface 12, processor 14, database 16, and maintenance interface 18 as desired. Embodiments of the software app 103 can include one or more computers that include one or more processors and memories configured for performing tasks described herein below. This can include, for example, a computer having a central processing unit (CPU) and non-volatile memory that stores software instructions for instructing the CPU to perform at least some of the tasks described herein. This can also include, for example, two or more computers that are in communication via a computer network, where one or more of the computers includes a CPU and non-volatile memory, and one or more of the computer's non-volatile memory stores software instructions for instructing any of the CPU(s) to perform any of the tasks described herein. Thus, while the exemplary embodiment is described in terms of a discrete machine, it should be appreciated that this description is non-limiting, and that the present description applies equally to numerous other arrangements involving one or more machines performing tasks distributed in any way among the one or more machines. It should also be appreciated that such machines need not be dedicated to performing tasks described herein, but instead can be multi-purpose machines, for example computer workstations, that are suitable for also performing other tasks. Furthermore the computers may use transitory and non-transitory forms of computer-readable media. Non-transitory computer-readable media is to be interpreted to comprise all computer-readable media, with the sole exception of being a transitory, propagating signal.

The I/O interface 12 provides a communication link between external users, systems, and data sources and components of the software app 103. The I/O interface 12 can be configured for allowing one or more users to input information to the software app 103 via any known input device. Examples can include a keyboard, mouse, touch screen, microphone, and/or any other desired input device. The I/O interface 12 can be configured for allowing one or more users to receive information output from the software app 103 via any known output device. Examples can include a display monitor, camera, a printer, a speaker, and/or any other desired output device. The I/O interface 12 can be configured for allowing other systems to communicate with the software app 103. For example, the I/O interface 12 can allow one or more remote computer(s) to access information, input information, and/or remotely instruct the software app 103 to perform one or more of the tasks described herein. The I/O interface 12 can be configured for allowing communication with one or more remote data sources. For example, the I/O interface 12 can allow one or more remote data source(s) to access information, input information, and/or remotely instruct the software app 103 to perform one or more of the tasks described herein.

The database 16 provides persistent data storage for software app 103. While the term “database” is primarily used, a memory or other suitable data storage arrangement may provide the functionality of the database 16. In alternative embodiments, the database 16 can be integral to or separate from the software app 103 and can operate on one or more computers. The database 16 preferably provides non-volatile data storage for any information suitable to support the operation of the software app 103.

The maintenance interface 18 is configured to allow users to maintain desired operation of the software app 103. In some embodiments, the maintenance interface 18 can be configured to allow for reviewing and/or revising the data stored in the database 16 and/or performing any suitable administrative tasks commonly associated with database management. This can include, for example, updating database management software, revising security settings, and/or performing data backup operations. In some embodiments, the maintenance interface 18 can be configured to allow for maintenance of the processor 14 and/or the I/O interface 12. This can include, for example, software updates and/or administrative tasks such as security management and/or adjustment of certain tolerance settings.

It is understood that system 101 may be operable through one or more computer systems for viewing outside of the kiosk from a remote location. Such an example may be Dispatch where a remote computer system is used away from the kiosk to coordinate activities.

The “ezVSF” is intended to be both practical and functional. The manufacturer's marketability is enhanced by the relative simplicity of manufacturing and reasonably priced components. Improved user experience and interactions within vehicle storage facilities benefit the user, which should generate significant market interest in the product.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A kiosk system, comprising:
a remote electronic device having a software application configured to track and handle repossession of a vehicle;
a dispatch system in communication with the remote electronic device, the dispatch system including a GPS system linked through a mobile network to provide location information related to the vehicle and a repo driver handling the repossession of the vehicle; and
a local kiosk system including an interface for access by a user to initiate retrieval of the vehicle, the local kiosk system in communication with the dispatch system to track the temporary release and movement of the vehicle.

2. The system of claim 1, wherein the dispatch system is configured to extract information from DMV reports.

3. The system of claim 1, wherein the dispatch system is configured to monitor and track performance for repo drivers.

4. The system of claim 1, wherein the dispatch system is configured to recommend dispatch decisions based upon repo driver performance.

5. The system of claim 1, wherein the GPS system includes a camera.

6. The system of claim 5, wherein the camera will include event detection and notification capabilities to assess when an incident with the vehicle has occurred and transmit such event via a notification to a remote party.

7. The system of claim 5, wherein the local kiosk is configured to accept payment and provide location of the vehicle.

8. The system of claim 1, wherein the interface of the local kiosk system includes a scanner configured to capture image data of a user and of documents.

9. The system of claim 1, wherein the local kiosk is configured to accept payment and provide location of the vehicle.

10. The system of claim 1, wherein the software application is configured to regulate the dispatch processes and provide the repo driver the ability to mark the vehicle and manage dispatch calls.
